(19) United States
(12) Patent Application Publication
(10) Pub. No.: US 2006/0042070 A1
(43) Pub. Date: Mar. 2, 2006

(54) Internal surface treating method of hole before tapping on aluminumdiematerial, internal surface of hole processed casting structure, and industrial tool of internal surface improvement

(76) Inventor: Masamori Nishina, Kawasaki-Shi (JP)

Correspondence Address: Mavis S. Gallenson, Esq.;c/o LADAS & PARRY, Suite 2100, 5670 Wilshire Boulevard, Los Angeles, CA, 90036-5679, US

(21) Appl. No.: 11/150,857

(22) Filed: Jun. 10, 2005

(30) Foreign Application Priority Data
Nov. 26, 2003 (JP) 2003-395231

(51) Int. Cl. B23P 17/00

(52) U.S. Cl. 29/527.5

(57) ABSTRACT

The present invention provides a improvement method of an internal surface of a hole of a casting in which an internal surface of a hole formed in a casting made of nonferrous metal is processed at high speed without excessively heating the same, thereby splitting and eliminating casting nests which are peculiar to the casting, and metal structure is reformed so that fluid does not leak from the casting nests formed in the casting, and to provide a casting structure whose hole internal surface of is improved, and a processing tool of the internal surface. A tool having a cross section area greater than that of a hole formed in the casting is sent and press-fitted into the hole while rotating the tool, friction heat is generated between a surface of the tool and the internal surface of the hole and then, the tool is pulled out from the hole in a state in which the rotation of the tool is maintained, thereby reforming a metal structure of the internal surface to form a reformed layer.

### BACKGROUND OF THE INVENTION

1. Field of the Invention

The present invention relates to a improvement method of an internal surface of a hole having a circular cross section formed in a casting, a casting structure whose hole internal surface is improved, and a processing tool for improvement the internal surface.

2. Prior Art

In a conventional casting product, metal crystal grain is coarse and when fluid such as gas or liquid is contained in holes of a casting, the fluid leaks between the machined holes formed in the casting in some cases. If a case locker of an engine part having an oil passage constituting a hydraulic circuit is produced by aluminum die-casting by drilling process and a plurality of screw holes are formed in the vicinity of the oil passage, there is a problem that oil flowing through the oil passage permeates through casting nests and the like formed between the metal structures, and oil leaks from the oil passage into the screw hole.

As a method for solving such a problem, there is a known method in which resin, water glass or the like is partially impregnated (organic impregnation, inorganic impregnation) through the screw hole, thereby preventing oil from oozing into the screw hole. In addition, there are also a known method that another pipe member is press-fitted into the screw hole, and a known method that a part which is previously formed with a screw thread is embedded into a desired position.

According to the conventional leakage preventing method as described in patent document 1 (Japanese Patent Laid-open No. H 5-237726), there is a drawback that an impregnating step such as resin is required in addition to a machining step using an NC machine tool, and working efficiency is deteriorated. This problem is also caused when a method for reforming a metal structure using electron beam, laser or the like, and especially in the die-cast, there is a problem that blister and the like are generated.

When the method in which another member is embedded in the screw hole is employed, there is a problem that a step for separating a part when defective parts are processed and recycle is carried out, and the efficiency of the recycling processing is deteriorated.

A columnar inner surface reforming method of a metal member described in patent document 2 (Japanese Patent Laid-open No. H2000-312980), a bottom surface of a worked hole is flat and a tool tip end is also flat. By inserting a tool having outer diameter greater than a diameter of the columnar (hole) surface, a difference surface between an inner diameter of the hole and an outer diameter of the tool is cut, and the metal inner surface of the hole is reformed by cutting heat and friction heat generated at that time. With a tool having a flat tip end, since the feeding force is excessively great, high speed feeding(e.g., 100 mm/min) is impossible. With the tool having the flat tip end, the friction heat is excessively high, as high as 410 to 470° C., there is a problem that thermal distortion is generated in a product, metal is cut down, effect for pushing the tool against the periphery becomes small, plastic flow is reduced on the contrary, pressure leakage can not be prevented.

When the cast is nonferrous metal such as aluminum, if its thickness variation is great, solidified structure of a thick portion thereof becomes uneven, and there is a problem that casting defect such as a pin hole and a casting nest is prone to be generated.

### SUMMARY OF THE INVENTION

The present invention has been accomplished in view of the above circumstances, and it is an object of the present invention to provide a improvement method of an internal surface of a hole of a casting in which an internal surface of a hole formed in a casting made of nonferrous metal is processed at high speed without excessively heating the same, thereby splitting and eliminating casting nests which are peculiar to the casting, and metal structure is reformed so that fluid does not leak from the casting nests formed in the casting, and to provide a casting structure whose hole internal surface of is improved, and a improvement tool of the internal surface.

The present invention relates to a improvement method of an internal surface of a casting, and the above object is achieved by the following method in which a tool having a cross section area greater than that of a hole formed in the casting is sent and press-fitted into the hole while rotating the tool, friction heat is generated between a surface of the tool and the internal surface of the hole and then, the tool is pulled out from the hole in a state in which the rotation of the tool is maintained, thereby reforming a metal structure of the internal surface to form a reformed layer.

The invention relates to a casting structure whose internal surface is improved, and the above object of the invention is achieved by the casting structure in which the casting structure has a reformed layer, the reformed layer is formed in such a manner that a tool having a cross section area greater than that of a molded hole formed in the casting is press-fitted into the hole while rotating the tool, friction heat is generated between a surface of the tool and the internal surface of the hole and then, the tool is pulled out from the hole in a state in which the rotation of the tool is maintained, thereby reforming a metal structure of the internal surface to form the reformed layer.

Further, the invention relates to a improvement tool for improvement an internal surface, and the above object of the invention is achieved by the improvement tool in which the tool is of rod-like structure having a circular cross section, and the tool comprises an inserting portion to be inserted into a molded hole of a casting, and a base end for supporting the inserting portion.

### BRIEF DESCRIPTION OF THE DRAWINGS

FIG. 1 is a sectional view showing an example of a shape of a hole formed in a casting.

FIG. 2 shows one example of a improvement tool used in the present invention.

FIG. 3 shows a detail structure of the tool.

FIG. 4 shows a state in which the tool is inserted into a hole (molded hole).

FIG. 5 is a sectional view of a hole showing a modification of a metal structure subjected to improvement of the invention.

FIG. 6 is a scatter diagram showing a relation between the revolution number of the tool and a feeding speed.

FIG. 7 is a sectional view showing a positional relation of an oil passage and the casting when a screw thread is formed in the casting.

FIG. 8 shows another example of the tool.

FIG. 9 shows another example of the tool.

FIG. 10 is a diagram (photograph) of a metal structure showing the effect of the invention.

FIG. 11 is a diagram (photograph) of a metal structure showing the effect of the invention.

FIG. 12 is a diagram (photograph) of a metal structure of a base material of the die-cast.

FIG. 13 shows a state in which a tool is inserted into a hole having no bottom.

### DESCRIPTION OF THE PREFERRED EMBODIMENTS

According to the present invention, a tool having a screw preparatory hole diameter is inserted into a molded and worked hole such as a die-cast casting member, a sand casting member, a mold casting member and a low pressure casting member at high speed rotation and feeding, thereby softening the raw material by friction heat generated at that time to generate plastic flow, metal is charged into casting nests, the casting nests are split and as a result, casting nest circuit which is a cause of pressure leakage is split and the pressure leakage is prevented. If the temperature of the friction heat becomes 350° C. or higher, the possibility that the raw material is deformed and blister is generated is increased and thus, the temperature of the friction heat is set in a range of 230 to 320° C.

The best mode for carrying out the present invention will be explained in detail with reference to the drawings.

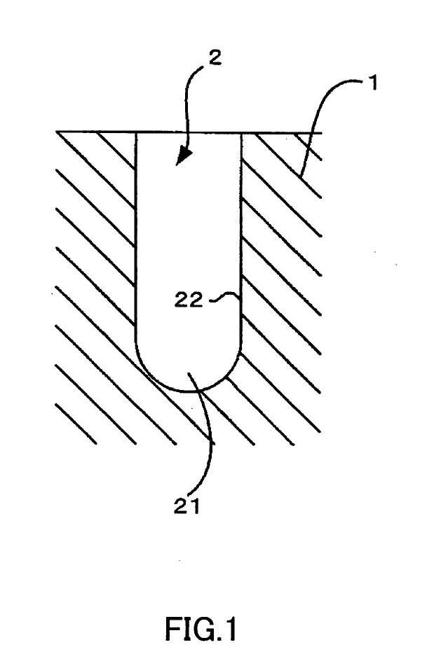

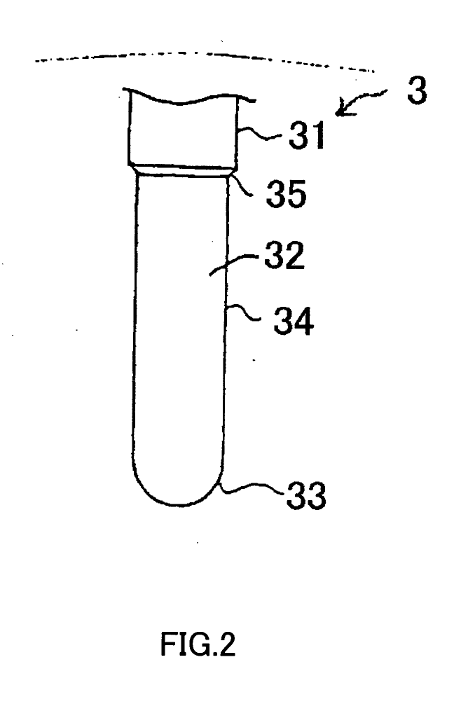

FIG. 1 shows a hole (molded hole) 2 formed in an aluminum die-cast casting 1. A cross section area of the hole 2 is gradually reduced (tapered) toward a bottom 21. The bottom 21 of the hole 2 is a semi-spherical recessed surface. A tool 3 of the invention which improves an internal surface 22 of the hole 2 has a structure shown in FIG. 2. That is, the tool 3 is made of high speed tool steel (SKH), and is of rod-like shape having a circular cross section. The tool 3 has a diameter corresponding to a diameter of the hole 2 (slightly larger), and has an inserting portion 32 for improvement the internal surface 22, and a base end 31 which has a greater diameter than that of the inserting portion 32 and which supports the inserting portion 32. A tip end of the inserting portion 32 is a semi-spherical projection, and has a tapered portion whose cross section area is gradually reduced toward the tip end. This taper angle is equal to or greater than an inclination angle of the inner peripheral surface of the hole 2. The length L of the inserting portion 32 is equal to or slightly longer than the depth of the hole 2. A base end 31 of a boundary portion between the inserting portion 32 and the base end 31 is rounded (R) or is a chamfered inclined shape 35.

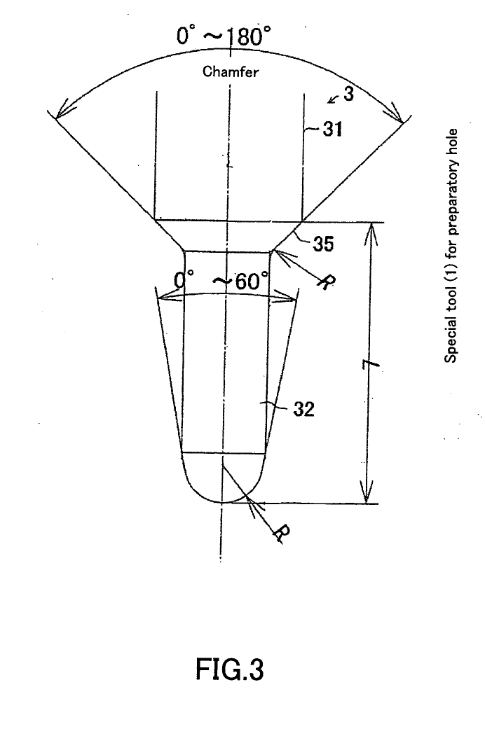

FIG. 3 shows a detailed structure of the tool 3. The inserting portion 32 is tapered in a range of 0 to 60° in accordance with the tapered degree of the hole 2. The base end 31 may be chamfered in a range of 0 to 180°.

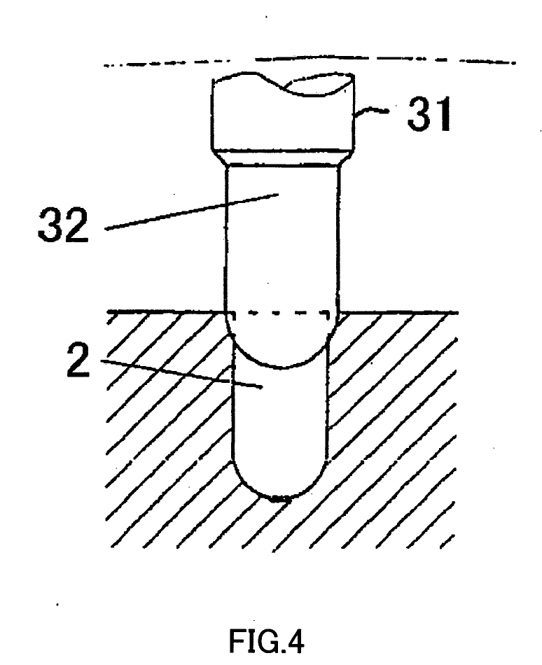

As shown in FIG. 4, the tool 3 is disposed on the axis of the hole 2 with respect to the hole 2 formed on the casting 1, the tool 3 is rotated (1600 to 8000 rpm) and in this state, the tool 3 is inserted into the hole 2 (feeding speed is 100 to 500 mm/min). Since the outer diameter of the inserting portion 32 of the tool 3 is slightly greater than the inner diameter of the hole 2, the outer peripheral surface 34 of the tool 3 and the inner wall (inner peripheral surface) 22 of the hole 2 are brought into contact with each other under pressure and they are relatively rotated (tool 3 is rotated in this embodiment). Therefore, high friction heat is generated between both surfaces thereof, and the metal structure of the internal surface of the hole 2 is plastically deformed by this generated friction heat. Since the inserting portion 32 of the tool 3 is tapered in accordance with the tapered degree of the hole 2, the outer peripheral surface 34 of the tool 3 can efficiently be brought into contact with the internal surface 22 of the hole 2 without gap. Since the tip end 33 of the tool 3 is the semi-spherical projection, a pushing force of the tip end 33 against the casting 1 is more effectively applied by the rotation and feeding motion of the tool 3 and friction is generated, thereby generating friction heat in the internal surface 22 of the hole 2, fine metal structure can be formed, casting nests in the inner wall can be split and disappeared, and the metal structure is split.

If the tool 3 is fully inserted into the hole 2, the inclined shape 35 of the base end 31 abuts against an upper portion of the internal surface 22. Therefore, even if burr and the like generated by the friction project from the hole 2, it can reliably be eliminated.

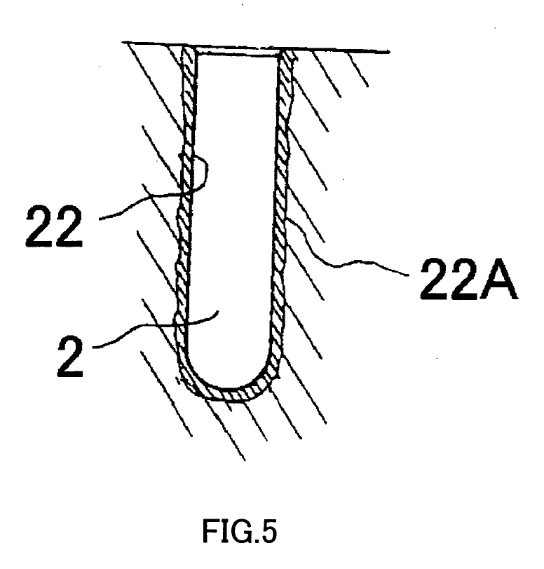

By pulling out the tool 3 from the hole 2 while rotating the tool 3, a base of the casting 1 absorbs heat, and the heated portion is rapidly cooled. The tool 3 is pulled out with the revolution number of 1600 to 8000 rpm like the inserting operation, but this rotation may also be carried out relatively. This is a necessary condition for reducing adhesion of raw material metal to the tool 3 to obtain smooth finished surface. By keeping the rotation to keep supplying the friction heat to peripheries, and binding force of the tool 3 caused by shrinkage of the raw material is reduced, rotation resistance is reduced and with this, a smooth surface can be obtained. With this, a reformed layer 22A shown in FIG. 5 is formed at a depth of 0.5 to 3.0 mm from the internal surface of the hole 2. The reformed layer 22A is a layer in which the metal structure of the casting 1 is reformed. This layer has finer metal structure as compared with metal structure of other portion. Since the tool 3 of the invention has the inclined shape 35 on a lower portion of an outer side of the base end 31, the inclined shape 35 comes into contact with the upper portion of the inner wall of the hole 2 to remove the burr and the like, and this portion becomes smooth and flat.

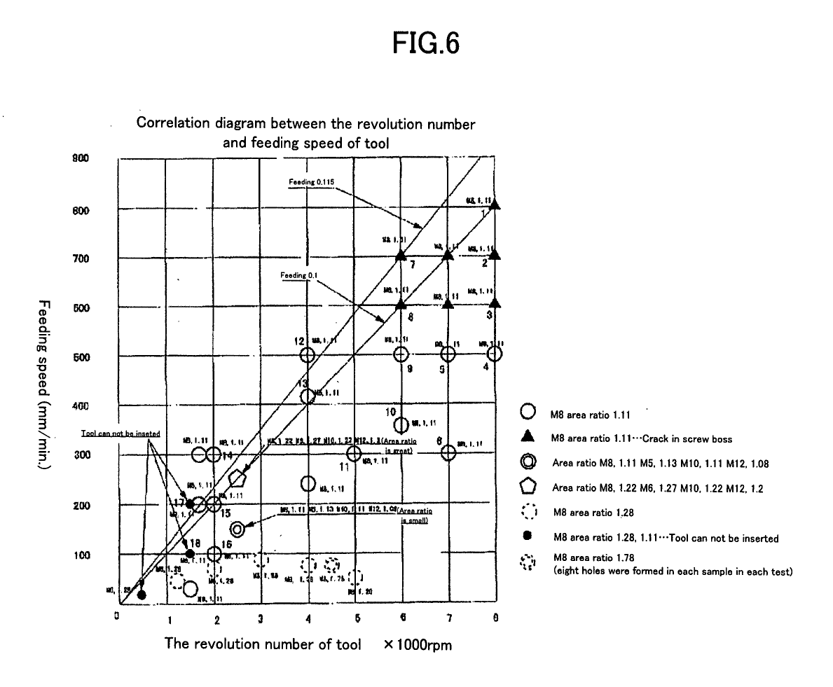

In order to efficiently produce such a reformed layer 22A, the revolution number of the tool 3 is set in a range of 1600 to 8000 rpm. If the revolution number is smaller than this range, sufficient heat can not be obtained, and if the revolution number exceeds this range, power is used wastefully. The feeding speed of the tool 3 is preferably in a range of 100 to 500 mm/min. If the feeding speed is smaller than this range, the working efficiency is deteriorated, and if the feeding speed exceeds this range, the reformed layer 22A can not be formed sufficiently. FIG. 6 is a measured drawing of correlation between the revolution number (rpm) and the feeding speed (mm/min). As can be found in FIG. 6 that the revolution number of the tool 3 is in the range of 1600 to 8000 rpm, and the feeding speed of the tool 3 is in the range of 100 to 500 mm/min. If the internal surface is improved under this condition, adhesion of the casting metal to the tool 3 is reduced, and a smooth finished surface can be formed.

A relation between the tool diameter, the area ratio, the revolution number, the feeding speed and the temperature was as shown in Table 1, and it was confirmed that the friction temperature was in a range of 230 to 320° C. It can be found from Table 1 that if the revolution number was 1500 rpm and the feeding speed was in a range of 100 to 300 mm/min, the tool could not be inserted, and if the revolution number was in the range of 6000 to 8000 rpm and the feeding speed was in a range of 500 to 800 mm/min, since heat was not transferred to a back boss, a crack was generated in the back boss of the product. If the tool is pulled out from the hole with the revolution number is zero, deposited aluminum generates a vertical burr on an entrance of the hole 2.

TABLE 1
Forming data

| | | | | Forming condition | | Forming state | Temperature of |
|---|---|---|---|---|---|---|---|
| | | Tool | | Revolution | Feeding | ◯. . . Excellent | screw boss |
| | Nominal size | diameter | Area | number | speed | ●. . . Tool can not be inserted | Max Temperature |
| Sample No. | of screw | (mm) | ratio | (rpm) | (mm/min) | ▴. . . Screw boss becomes cracked | (° C.) |
| 1 | M8 × 1.25 | 6.85 | 1.11 | 8000 | 800 | ▴ (Back boss became cracked in two of eight holes) | 250 |
| 2 | M8 × 1.25 | 6.85 | 1.11 | 8000 | 700 | ▴ (Back boss became cracked in two of eight holes) | 260 |
| 3 | M8 × 1.25 | 6.85 | 1.11 | 8000 | 600 | ▴ (Back boss became cracked in two of eight holes) | 280 |
| 4 | M8 × 1.25 | 6.85 | 1.11 | 7000 | 300 | ◯ | 320 |
| 5 | M8 × 1.25 | 6.85 | 1.11 | 6000 | 700 | ▴ (Back boss became cracked in two of eight holes) | 260 |
| 6 | M8 × 1.25 | 6.85 | 1.11 | 6000 | 600 | ▴ (Back boss became cracked in two of eight holes) | 250 |
| 7 | M8 × 1.25 | 6.85 | 1.11 | 6000 | 500 | ▴ (Back boss became cracked in two of eight holes) | 280 |
| 8 | M8 × 1.25 | 6.85 | 1.11 | 6000 | 360 | ◯ | 300 |
| 9 | M8 × 1.25 | 6.85 | 1.11 | 5000 | 300 | ◯ | 270 |
| 10 | M8 × 1.25 | 6.85 | 1.11 | 4000 | 500 | ◯ | 240 |
| 11 | M8 × 1.25 | 6.85 | 1.11 | 4000 | 420 | ◯ | 240 |
| 12 | M8 × 1.25 | 6.85 | 1.11 | 2000 | 300 | ◯ | 250 |
| 13 | M8 × 1.25 | 6.85 | 1.11 | 2000 | 200 | ◯ | 250 |
| 14 | M8 × 1.25 | 6.85 | 1.11 | 2000 | 100 | ◯ | 230 |
| 15 | M8 × 1.25 | 6.85 | 1.11 | 1500 | 200 | ● (Back boss became cracked in all of eight holes) | — |
| 16 | M8 × 1.25 | 6.85 | 1.11 | 1500 | 100 | ● (Back boss became cracked in all of eight holes) | — |

| | |
|---|---|
| Each sample was formed with eight holes | Measured position |
| | 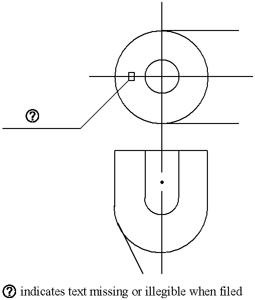 |

Table 2 shows a relation of a ratio of a cross section area to the diameter of screw preparatory hole. In this invention, cross section area ratio of 1.05 to 1.30 times (1.02 to 1.14 times in diameter) is used. As can be seen from Table 2, sufficient friction heat is not generated if the cross section area ratio is 1.05 times or less, and if the ratio is 1.30 times or more, friction heat is excessively generated, raw material temperature rises and deformation is generated. If the cross section area ratio is 1.30 times or more. In order to generate the friction heat, it is necessary to form the hole at feeding speed of 100 mm/min or less, productivity is not sufficient. If the feeding speed is reduced, the temperature of generated heat rises, and there is a problem that a product is deformed. In the case of a normal die-cast casting member, it is possible to form a screw preparatory hole having not swelling burr if the cross section area ratio of the tool is 1.30 times or less. Since a normal die-cast casting is molded by high speed injection, a large number of casting nests and gas porosities exist and thus, metal is charged into such portion and swelling is not generated.

TABLE 2
No leaking
Cross section area ratio of screw preparatory hole processing

| | | | Coarse material | |
|---|---|---|---|---|
| | | Preparatory hole | hole drill | |
| | | diameter of screw | diameter (Molded | Cross section |
| Name of | | (Tool diameter) | hole diameter) | area ratio |
| screw | Pitch | φmm 85% | φmm | (%) |
| M3 | 0.50 | 2.57 | 2.3˜2.4 | 1.25˜1.15 |
| M4 | 0.70 | 3.36 | 3.0˜3.2 | 1.25˜1.10 |
| M5 | 0.80 | 4.26 | 3.8˜4.0 | 1.28˜1.13 |
| M6 | 1.00 | 5.08 | 4.5˜4.8 | 1.27˜1.12 |
| M8 | 1.25 | 6.85 | 6.0˜6.5 | 1.30˜1.11 |
| M10 | 1.50 | 8.62 | 7.6˜8.2 | 1.29˜1.11 |
| M12 | 1.75 | 10.3 | 9.1˜9.8 | 1.28˜1.10 |
| M14 | 2.00 | 12.1 | 10.7˜11.6 | 1.28˜1.09 |
| M16 | 2.00 | 14.1 | 12.6˜13.6 | 1.25˜1.08 |
| M18 | 2.50 | 15.6 | 14.0˜15.0 | 1.24˜1.08 |
| M20 | 2.50 | 17.6 | 15.8˜17.0 | 1.24˜1.07 |
| M22 | 2.50 | 19.6 | 17.5˜19.0 | 1.25˜1.06 |
| M24 | 3.00 | 21.1 | 18.8˜20.3 | 1.26˜1.08 |
| M27 | 3.00 | 24.1 | 21.5˜23.3 | 1.26˜1.07 |
| M30 | 3.50 | 26.6 | 24.0˜25.8 | 1.23˜1.06 |
| M33 | 3.50 | 29.6 | 26.7˜28.8 | 1.23˜1.05 |

The tool 3 can be used in a mechanical processing line using a machine tool such as an NC machine tool and a radial ball drill press.

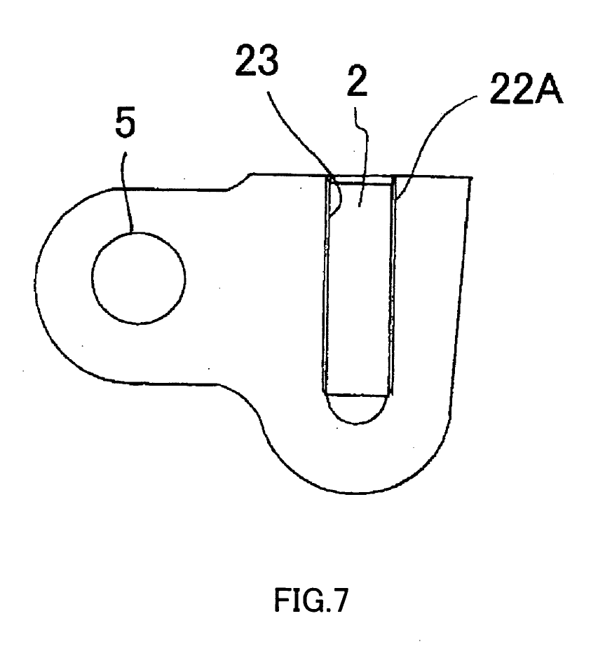

As shown in FIG. 7, the hole 2 formed with the reformed layer 22A in the above-described manner is formed with a female thread 23 by a tapping apparatus. When oil leaks from an oil passage 5 formed near the female thread 23, the reformed layer 22A suppresses or prevent oil from leaking into the hole 2.

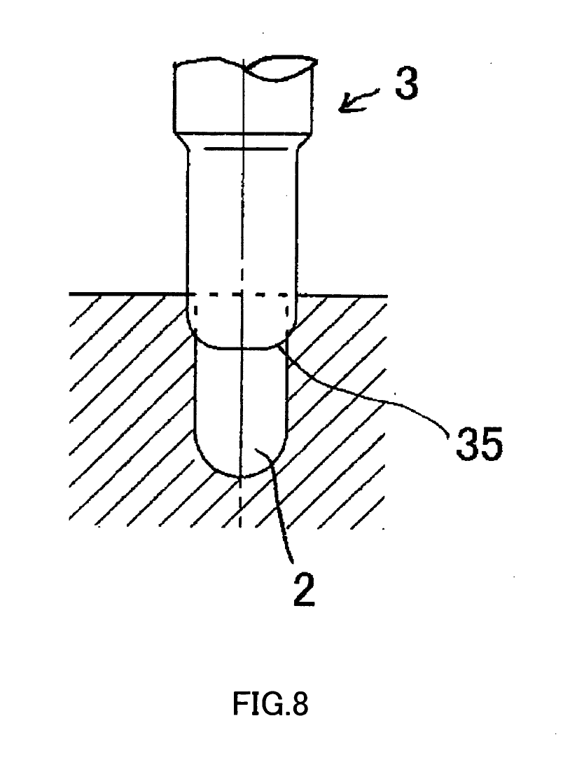

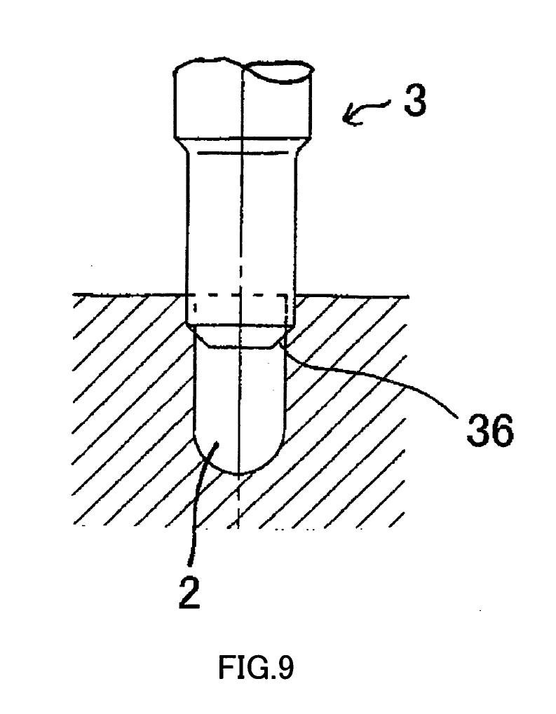

The tip end 33 of the tool 3 is formed into the semi-spherical projection, but the tip end may be founded (35) which is rounded (R)as shown in FIG. 8, or may be chamfered (36) as shown in FIG. 9. When the hole 2 is not tapered, the inserting portion 32 of the tool 3 may not be tapered.

In addition to the die-cast, the casting 1 also includes the mold casting, the sand casting, the low pressure casting and the like, and the casting 1 is not limited to the producing means. As the nonferrous metal, the casting material may be magnesium, or magnesium alloy, in addition to aluminum and aluminum alloy. Further, zinc alloy casting and copper alloy casting are also included in the casting.

Although the hole 2 is molded hole in this embodiment, the hole 2 may be drill hole formed by a drill or the like. A forming method of the preparatory hole is not especially limited. When the hole is a molded hole, this is especially preferable because a step for forming the hole is unnecessary, and no chippage is generated by the drilling. It is also preferable to form a hole using the drill, because it is unnecessary to change the shape of a mold, and it is easy to change the design. When a core pin can not be disposed due to a structure of mold or when a molded hole is too small and the molded hole does not exist, a drill worked hole corresponding to the molded hole can be used. In this case, the size of the drill worked hole is the same as that of the molded hole.

As a material of the tool 3, heat resistant tool steel made of alloy tool steel (SKS, SKD, SKH or the like) may be used, and the tool 3 may be subjected to carburization, nitriding, ceramic coating surface hardening processing to prevent aluminum from adhering. The tool 3 may have such a shape that its outer peripheral surface is formed with a screw. In this case, the tip end of the tool 3 is allowed to reach a bottom of the hole 2 and then, the tool 3 is rotated in a direction in which the screw is pulled out, the tool 3 is pulled out in accordance with pitch of the screw, and a screw can be formed simultaneously when the reformed layer 22A is produced.

A reforming method of a peripheral structure of the hole of the casting of the present invention is a hydraulic machine part having a hydraulic path therein, and a casting of a gas machine part provided with a gas path. Examples of such a casting for engine part are a locker cover, a case locker, a case bracket, a cylinder head, a cylinder block, a crankcase, an oil pan, a front cover, a case front, a retainer front, an inlet manifold, a case oil cooler, a case oil filter, a case rear, a housing flywheel and the like. Other examples are an engine part, a driving part, a hydraulic machine, a case and the like of a gas machine, a body and the like, a cover and the like. Examples of the driving part are a housing clutch, a case transmission, a gear box, a quotolant box, a rear cover and a housing extension.

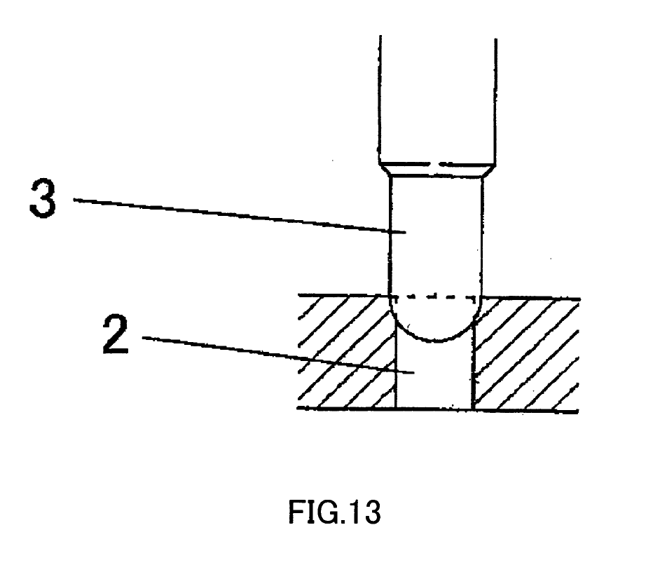

An embodiment of the present invention has been explained above, the described contents are one mode for carrying out the invention, and the invention is not limited to the embodiment. As shown in FIG. 13, the invention can also be utilized for an internal surface of a hole having no bottom.

According to the invention, it is possible to form a reformed layer of fine metal structure around a hole formed in a casting, and it is possible to suppress or prevent leakage of fluid into the hole, and a reformed layer can be produced efficiently by setting a cross section area of a tool tip end in a range of 1.05 to 1.30 times of a cross section area of the opening of the hole. Further, the reformed layer can efficiently be formed by setting the revolution number of a rod-like tool in a range of 1600 to 8000 rpm, and the reformed layer can efficiently be formed by setting the feeding speed of the rod-like tool in a high speed range of 100 to 500 mm/min.

Further, if a hole to be processed is a molded hole, a step for forming the hole is unnecessary, and no chippage is generated by the drilling. If the hole and the rod-like tool are formed into shapes having tapered portions, it becomes easy to apply pressure to the contact surface, friction heat can be obtained more reliably, and it becomes easy to produce the reformed layer.

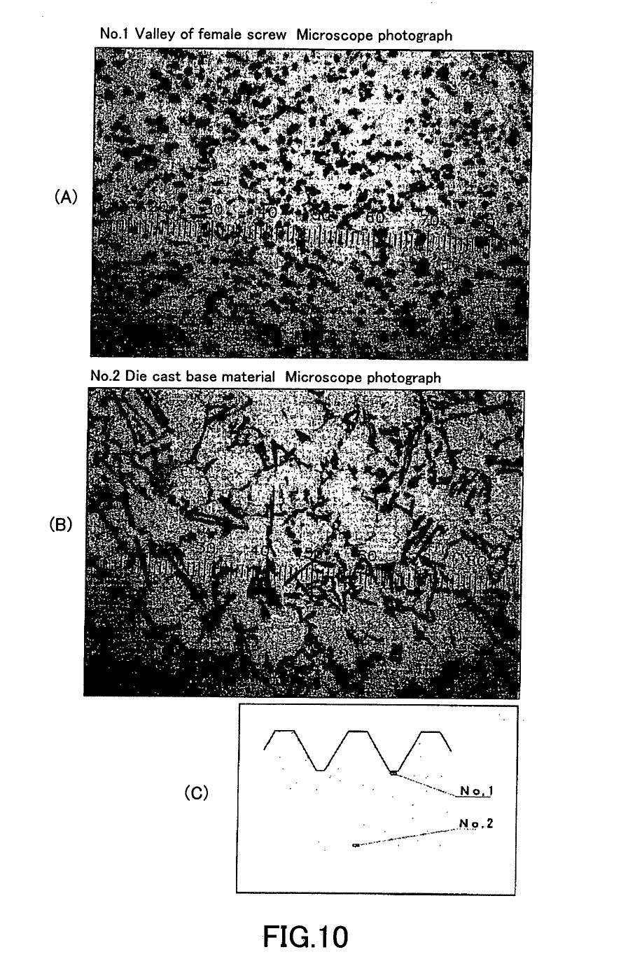

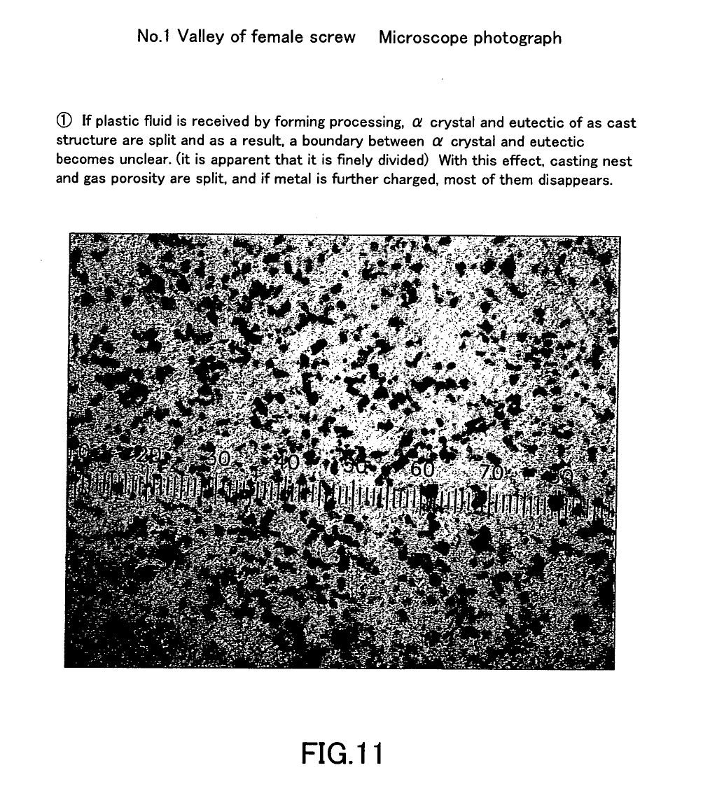

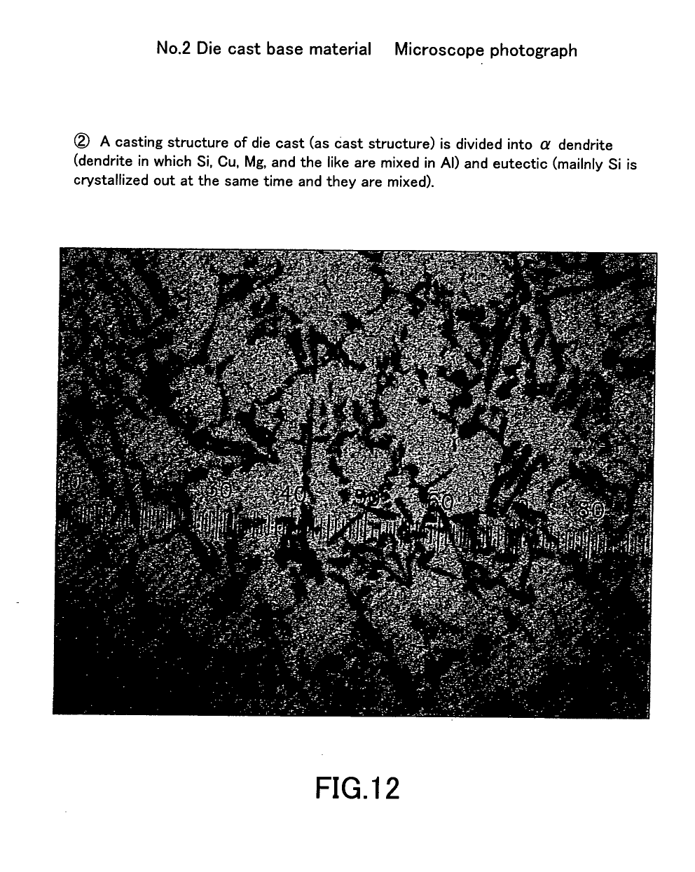

The reformed layer is a layer in which metal structure of the casting is reformed, and has finer metal structure as compared with metal structure of other portion. FIG. 10(A)shows a structure of a casting in a female screw root subjected to the improvement of the present invention, and FIG. 10(B) shows a structure of a normal base material of a casting. FIGS. 11 and 12 show detailed structure thereof. As shown in FIG. 12, a casting structure (as cast structure) of die-cast is divided into a dendrite (dendrite in which Si, Cu, Mg and the like are mixed in Al) and eutectic (mainly Si is crystallized out at the same time and they are mixed). Whereas, as shown in FIG. 11, in the case of a structure subjected to the improvement of the present invention, it can be found that if the structure receives plastic flowing by forming processing, α crystal and eutectic of the as cast structure are split and as a result, casting nests and gas porosities are split, and most of them disappear by charging metal.

1. An improvement method of an internal surface of a casting wherein a tool having a cross section area greater than that of a hole formed in the casting is sent and press-fitted into the hole while rotating the tool, friction heat is generated between a surface of the tool and the internal surface of the hole and then, the tool is pulled out from the hole in a state in which the rotation of the tool is maintained, thereby reforming a metal structure of the internal surface to form a reformed layer.

2. The improvement method of the internal surface of the casting according to claim 1, wherein the hole is a molded hole.

3. The improvement method of the internal surface of the casting according to claim 1, wherein the hole has a circular cross section and its bottom is concave, the tool has a rod-like shape, and a tip end of the tool is convex.

4. The improvement method of the internal surface of the casting according to claim 1, wherein the casting is a die-casting, a mold casting, a sand casting or a low pressure casting, and a material of the tool is a high speed tool steel or a heat resistant tool steel.

5. The improvement method of the internal surface of the casting according to claim 3, wherein a cross section area of the tool is 1.05 to 1.30 times of a cross section area of the hole.

6. The improvement method of the internal surface of the casting according to claim 3, wherein the revolution number of the tool is in a range of 1600 to 8000 rpm.

7. The improvement method of the internal surface of the casting according to claim 5, wherein feeding speed of the tool is in a range of 100 to 500 mm/min.

8. The improvement method of the internal surface of the casting according to claim 1, wherein a cross section area of the hole is gradually reduced toward its bottom, the tool is tapered such that its cross section area is gradually reduced toward its tip end.

9. The improvement method of the internal surface of the casting according to claim 8, wherein the casting is made of nonferrous metal.

10. A casting structure whose internal surface is improved comprising a reformed layer, wherein the reformed layer is formed in such a manner that a tool having a cross section area greater than that of a molded hole formed in the casting is press-fitted into the hole while rotating the tool, friction heat is generated between a surface of the tool and the internal surface of the hole and then, the tool is pulled out from the hole in a state in which the rotation of the tool is maintained, thereby reforming a metal structure of the internal surface to form the reformed layer.

11. The casting structure whose internal surface is improved according to claim 10, wherein the casting is a die-casting, a mold casting, a sand casting or a low pressure casting, and a material thereof is nonferrous metal.

12. The casting structure whose internal surface is improved according to claim 11, wherein a cross section area of the molded hole is gradually reduced toward its bottom.

13. A processing tool for improvement of an internal surface, the tool is of rod-like structure having a circular cross section, comprising an inserting portion to be inserted into a molded hole of a casting, and a base end for supporting the inserting portion.

14. The processing tool for improvement of the internal surface according to claim 13, wherein a material of the tool is a high speed tool steel or a heat resistant tool steel.

15. The processing tool for improvement of the internal surface according to claim 13, wherein the inserting portion is tapered such that its cross section area is gradually reduced toward its tip end.

16. The processing tool for improvement of the internal surface according to claim 15, wherein the tip end is of semi-spherical shape.

17. The casting structure whose internal surface is improved according to claim 15, wherein the tip end is rounded.

18. The casting structure whose internal surface is improved according to claim 15, wherein the tip end is chamfered.
